(19) United States
(12) Patent Application Publication
(10) Pub. No.: US 2026/0064505 A1
(43) Pub. Date: Mar. 5, 2026

(54) APPLICATION PROGRAMING INTERFACE (API) SPECIFICATION PROCESSING SYSTEM

(71) Applicant: Oracle International Corporation, Redwood Shores, CA (US)

(72) Inventors: Mathias Guenter Ricken, Seattle, WA (US); Jeffrey Stephen Ford, Redmond, WA (US)

(73) Assignee: Oracle International Corporation, Redwood Shores, CA (US)

(21) Appl. No.: 18/821,800

(22) Filed: Aug. 30, 2024

(51) Int. Cl. G06F 9/54

(52) U.S. Cl. CPC G06F 9/547

(57) ABSTRACT

A technique is disclosed that facilitates the efficient creation and processing of an API specification for a service. The technique enables a particular service within an enterprise to use a function provided by another service within the enterprise in the API specification associated with the particular service, where the description of the function is not copied into the API specification. In certain embodiments, an include file is created that comprises a description of the function. The include file is identified and provided in the API specification of the particular service. An API specification generation system then processes the API specification comprising the include file to generate a final API specification for the service. The final API specification is provided via a user interface of a computing device.

### BACKGROUND

An Application Programing Interface (API) specification is commonly provided for cloud services for describing the resources and functions provided by the cloud services in an API description format. The API specification describes the API endpoint and the operations that can be performed on each endpoint used by the API, the input and output parameters used by each operation, authentication methods used by the API, license information associated with the API and so on.

Quite often a function provided by a first service within an enterprise is used by other services within the enterprise in conjunction with various resources provided by those services. In such a use case, current approaches for enabling a particular service to use the function provided by the first service involves copying the description of the function from the API specification of the first service into the API specification for the particular service. If the same function is used for multiple resources in the particular service, then multiple copies of the function description are made in the API specification of the particular service and each copy is modified for the particular resources.

The above practice suffers from several drawbacks. As a result of multiple copying, API specifications often have parts (e.g., the same function can be used for multiple resources provided by a particular service) that are repeated many times, both inside the same specification for one service, as well as across multiple specifications for many different services. Due to the multiple copying and amending of the function descriptions within a specification, differences can creep in-some inadvertent, some intentional. This can cause the descriptions to diverge with very little control on the API specification. The situation can become even more complicated when the description for the original function changes. Making the same changes to multiple parts of the API specification across multiple services can be a cumbersome and time consuming process. Thus, there is a need for developing techniques that facilitate more efficient creation and processing of API specifications than what is possible by existing implementations.

### BRIEF SUMMARY

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

The present disclosure relates generally to techniques that facilitate the efficient creation and processing of an API specification for a service. More specifically, but not by way of limitation, this disclosure describes a technique for enabling a particular service within an enterprise to use a function provided by another service within the enterprise in the API specification associated with the particular service, where the description of the function is not copied into the API specification. In certain embodiments, an include file is created that comprises a description of the function. The include file is identified and provided in the API specification of the particular service. An API specification generation system then processes the API specification comprising the include file to generate a final API specification for the service. The final API specification is provided to a requesting user via a user interface of a computing device.

In certain embodiments, the API specification generation obtains information that identifies an include file that describes a function provided by a first service. The first service may represent a cross-platform service within the enterprise that is capable of providing various types of functions to multiple other services within the enterprise. The “include file” for a function comprises a detailed description of the function such as the input and output parameters of the function, the endpoint of the function, the request and response schema associated with the function and so on. In a certain implementation, the API specification generation system may obtain the information that identifies an include file from a user of a service team responsible for the service via a User Interface (UI) in the API specification generation system.

The API specification generation system then adds the information identifying the “include file” in the API specification for a second service. In a certain implementation, the information identifying the include file is added via the UI by specifying path information that identifies a location (e.g., a URL) of the include file. The second service uses the function described in the include file for a set of one or more resource types provided by the second service. In certain examples, the API generation system obtains information identifying one or more resource-specific scope portions for describing application of the function described in the include file to the set of one or more resource types provided by the second service.

In certain examples, a first resource-specific scope portion from the one or more resource-specific scope portions identifies a first resource type from the set of one or more resource types provided by the second service and is identified by setting a resource name parameter used by the function to the first resource type in the first resource-specific portion.

In certain examples, a second resource-specific scope portion from the one or more resource-specific scope portions identifies a second resource type from the set of one or more resource types provided by the second service and is identified by setting a resource name parameter used by the function to the second resource type in the second resource-specific portion. In certain examples, the first resource type is different from the second resource type.

In certain examples, the API specification generation system adds the one or more resource-specific scope portions into the API specification for the second service to generate the modified API specification. In one implementation, the resource-specific scope portions are added into the API specification for the second service via a User Interface (UI) of the API generation system.

In certain examples, the API specification generation system processes the modified API specification to generate a final API specification for the second service. The results of the processing performed by the API document generation system are then communicated back to a requesting user via a User Interface (UI) of the API specification generation system.

### BRIEF DESCRIPTION OF THE DRAWINGS

Features, embodiments, and advantages of the present disclosure are better understood when the following Detailed Description is read with reference to the accompanying drawings.

FIG. 1 depicts a simplified diagram of a computing environment that includes an Application Programing Interface (API) specification generation system that includes capabilities for efficiently creating and processing an API specification for a service, according to certain embodiments.

FIG. 2 depicts a block diagram of an API specification generation system that includes capabilities for efficiently creating and processing an API specification for a service, according to certain embodiments, according to certain embodiments.

FIG. 3 is an illustration of an API specification preprocessor file (ASPF)) created for a service, according to certain embodiments.

FIG. 4 depicts an example of a process performed by the API specification generation system shown in FIG. 1, according to certain embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to techniques that facilitate the efficient creation and processing of an API specification for a service. More specifically, but not by way of limitation, this disclosure describes a technique for enabling a particular service within an enterprise to use a function provided by another service within the enterprise in the API specification associated with the particular service, where the description of the function is not copied into the API specification. In certain embodiments, an include file is created that comprises a description of the function. The include file is identified and provided in the API specification of the particular service. An API specification generation system then processes the API specification comprising the include file to generate a final API specification for the service. The final API specification may be consumed by a computing device or a computing process and used to build service code such as user interfaces, Software Development Kits (SDKs), Command Line Interfaces (CLIs) and so on.

As described in the Background section, current approaches for enabling a particular service within an enterprise to use the function provided by a first service within the enterprise typically involves copying the description of the function from the API specification of the first service into the API specification for the particular service. If the same function is used for multiple resources in the particular service, multiple copies of the function description are typically made in the API specification of the particular service and then each copy is modified for the particular resources.

For example, the first service may represent a cross platform service within an enterprise (organization). The first service may provide a function (e.g., a function for locking a resource), where the function is described in the API specification for the first service. The resource locking function provided by the first service may be used by various other services for locking various resources provided by those services. For example, a second service in the enterprise may use the function provided by the first service to lock one or more types of resources (such as instances, images, buckets, databases and so on) provided by the second service. For example, a second service that includes capabilities to create and manage database resources can use the resource locking function provided by the first service to lock and unlock its database resources. In current approaches, a person (e.g., a user) associated with a service team that is responsible for the second service has to manually copy the section that describes the resource locking function from the API specification associated with the first service into the API specification associated with the second service and then modify this section to make it applicable for a particular resource type provided by the second service. If the second service provides the resource locking functionality for multiple resource types provided by the second service, then multiple copies of the section have to be added to the API specification for the second service and each copy has to be modified (amended) for a particular resource type to which the function is applied. Manual copying can introduce errors and is time consuming and burdensome.

Additionally, even in one API specification written for a particular service or two closely related services, there may be differences in the function description used by the services. The description for a function generally comprises several lines of code and when this description is copied and repeated multiple times in the API specification, the API specification becomes uncontrollably large making it difficult to read it or to check it for correctness. When there are small differences made to the description of a function by different service teams, changes and errors can creep in making it difficult to check errors. If changes are made to the function, the entire function has to be copied again making it time consuming and burdensome.

The various embodiments described in the present disclosure address the deficiencies of existing approaches by disclosing an API specification generation system that facilitates the efficient creation and processing of an API specification for a service. The system includes capabilities for enabling a particular service within an enterprise to utilize a function provided by another service in the API specification associated with the particular service, where the description of the function is not copied into the API specification associated with the particular service. In certain embodiments, for a first service (which may represent a cross-platform service team) within an enterprise that is providing a function that is going to be potentially used by multiple other service teams on different resource types provided by those service teams, an “include file” is created by a service team responsible for the first service. The “include file” for a function comprises a detailed description of the function such as the input and output parameters of the function, the endpoint of the function, the request and response schema associated with the function and so on.

The include file is then identified in the API specification of a service that is going to use the function. Since the include file contains a description of the function, the entire function description and its associated code does not have to be copied each time the function is used in the API specification for the service. The include file can additionally be used in conjunction with various resource types provided by the service. To utilize the function described in the include file in conjunction with various resource types provided by the service, in certain examples, for each resource type, a resource-specific scope portion is added to the API specification. The resource-specific scope portion identifies a resource type from a set of resource types used by the function described in the include file. The resource type is identified by setting a resource name parameter used by the function to the resource type in the resource-specific scope portion. In certain implementations, multiple resource-specific scope portions may be defined in the API specification to utilize the function described in the include file in conjunction with various resource types provided by the service.

By identifying and providing an include file that comprises a description of the function in an API specification associated with the service, when a modification is made to the original function description, only the modified and upgraded version of the include file needs to be made available (e.g., by a service team that provides the include file) to other services that want to utilize the function described in the include file. Additionally, since the include file can be used in conjunction with various resource types provided by the service, the entire function description does not have to be copied each time the function is used for various resource types provided by the service. Thus, by creating and using include files as described in this disclosure, service teams do not have to copy and amend the function description and its associated code multiple times within the API specification which is a manual and time consuming process that is prone to errors. The reduction of duplicated code in an API specification also makes it less likely that service teams accidentally introduce mistakes that typically occur while copying and pasting functional descriptions multiple times into an API specification.

The addition of the include file and the resource-specific scope portions in the API specification for a service as described above results in the creation of a modified API specification for a service. The modified API specification represents an intermediate API specification (also referred to herein as an API specification preprocessor file (ASPF)) for the service. The ASPF for the service is then provided to an API specification generation system for processing. The API specification generation system processes the ASPF for a service and generates a final API specification for the service based on the processing using automated techniques. As part of generating the final API specification, in certain examples, the system may also display the final API specification via a user interface of a computing device of a requesting user as described in this disclosure.

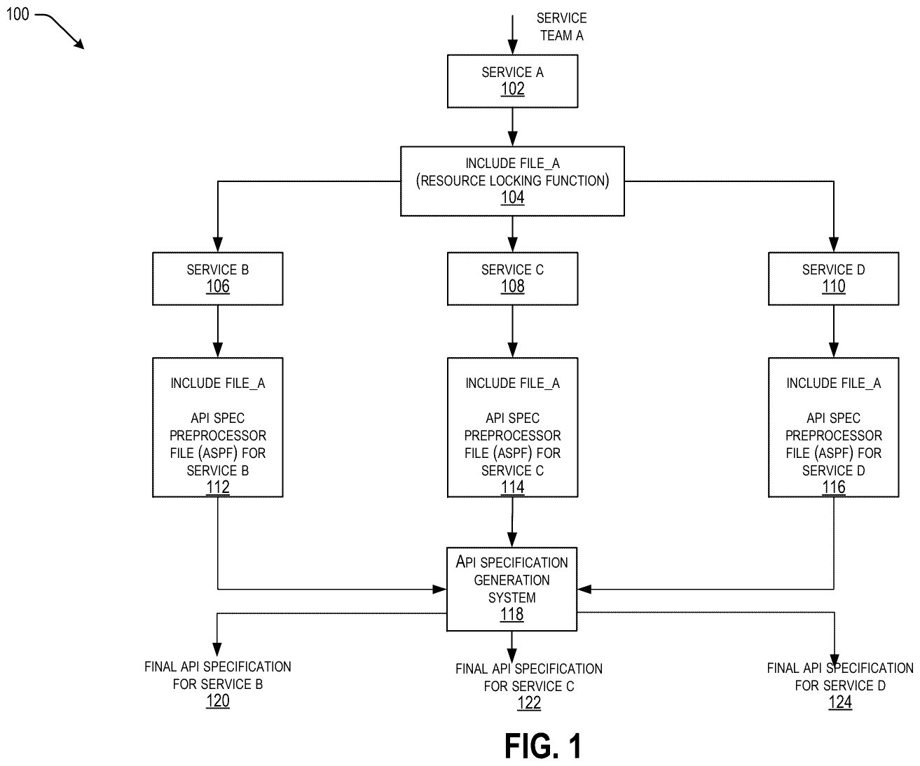

FIG. 1 depicts a simplified diagram of a computing environment that includes an Application Programing Interface (API) specification generation system that includes capabilities for efficiently creating and processing an API specification for a service, according to certain embodiments. In certain examples, the service may represent a cross-platform service within the enterprise that is capable of providing various types of functions to multiple other services within the enterprise. Examples of functions provided by such a cross-platform service may include, for instance, a resource locking function that describes a set of operations that can be performed for locking a resource, a change compartment function that describes a set of operations that can be performed to move a resource form one compartment into another compartment, and so on. A “compartment” may refer to a logical container that is used to organize and control access to a set of resources managed by the enterprise.

The embodiment depicted in FIG. 1 illustrates various services that can be provided within an enterprise. For instance, a first service (e.g. service A 102) may represent a cross-platform service in the enterprise that is capable of providing various types of functions to multiple other services (e.g., service B 106, service C 108 and service D 110) within the enterprise. Service A 102, Service B 106, service C 108, and service D 110 may represent services such as infrastructure management services, software development services, financial services, data management services, data storage services, security services and so on within an enterprise. For instance, the first service (e.g. service A 102) may provide a resource locking function 104 that can potentially be used by one or more services (e.g., service B 106, service C 108, and service D 110) within the enterprise in conjunction with various resource types (e.g., instances, images, buckets and so on) provided by those services.

To enable a particular service (e.g., service B 106, service C 108, or service D 110) to utilize the function provided by the first service (e.g., service A 102), in certain embodiments, an include file is created and provided by the first service. The “include file” for a function comprises a detailed description of the function such as the input and output parameters of the function, the endpoint of the function, the request and response schema associated with the function and so on. An example of an include file for a resource locking function is described in detail below. Different include files can be created to describe different functions provided by a service, where each include file comprises a description of a specific function provided by the service. For instance, a first include file can be created to describe a resource locking function, a second include file can be created to describe a compartment change function and so on.

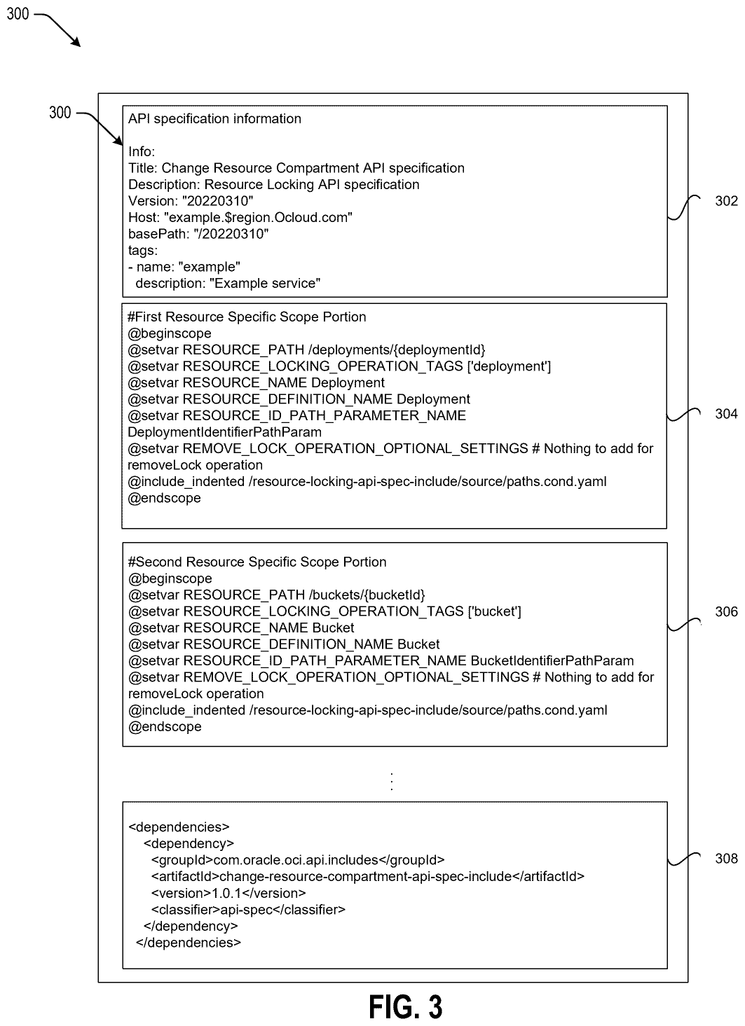

In certain examples, the include file is created by a service team responsible for the service. Other services (e.g., service B 106, service C 108, or service D 110) can then utilize the function described in the include file by identifying the include file in an API specification associated with those services. For instance, as depicted in FIG. 1, a service team responsible for service B can identify an include file_A that describes a resource locking function 104 provided by service A 102 and add the include file_A into the API specification associated with service B 106. Similarly, a service team responsible for service C 108 can identify the include file_A provided by service A 102 and add the include file_A into the API specification associated with service C 108, a service team responsible for service D 110 can identify the include file_A provided by service A 102 and add the include file_A into the API specification associated with service D 110 and so on. In one implementation, the include file may be identified and added into the API specification by specifying a Uniform Resource Locator (URL) that identities the location of the include file in a repository accessible to the API specification generation system. Additional details of the manner in which an include file can be identified and added to an API specification associated with a service is described in detail in FIG. 3.

In certain situations, a particular service (e.g., service B 106, service C 108, or service D 110) may wish to utilize the function (i.e., the resource locking function) described in an include file (e.g., include file_A 104) provided by the first service (e.g., service A 102) in conjunction with various resource types (e.g., instances, images, buckets and so on) provided by the service. To utilize the function described in an include file in conjunction with various resource types provided by a particular service, in certain examples, for each resource type, a resource-specific scope portion is added to the API specification. The resource-specific scope portion identifies a resource type from a set of resource types used by the function described in the include file. The resource type is identified by setting a resource name parameter used by the function to the resource type in the resource-specific scope portion. In certain cases, multiple scope portions may be defined in the API specification to utilize the include file in conjunction with various resource types provided by the service. An example multiple resource-specific scope portions identified in an API specification for a service is described in FIG. 3.

By enabling a service to utilize a function by identifying and providing an include file that describes the function in an API specification associated with the service, the entire function description and its code does not have to be copied each time the function is used by the service for various resource types provided by the service. Additionally, when a modification is made to the original function description, only the modified and upgraded version of the include file needs to be made available (e.g., by a service team that provides the include file) to other services that want to utilize the function described in the include file. Thus, by creating and using include files as described in this disclosure, service teams do not have to copy and amend the function description and its associated code multiple times within the API specification which is a manual and time consuming process that is prone to errors. The reduction of duplicated code in an API specification also makes it less likely that service teams accidentally introduce mistakes that typically occur while copying and pasting functional descriptions multiple times into an API specification.

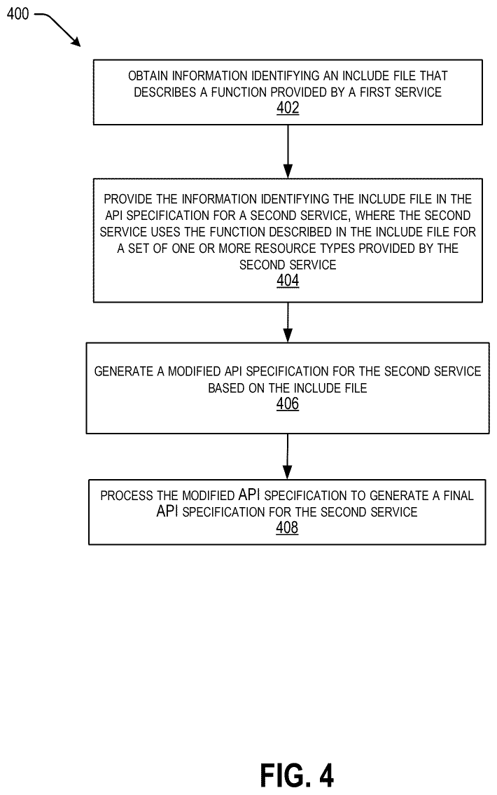

The API specification for the service can thus be modified as described above to identify an include file that describes a function that the service wants to utilize. The API specification for the service can additionally be modified to define resource-specific scope portions so that the function described in the include file can be applied to various resource types provided by the service. The modified API specification represents an intermediate API specification (also referred to herein as an API specification preprocessor file (ASPF) for the service. An example of an ASPF comprising an include file that describes a resource locking function and defines multiple scope portions for various resource types used by the resource locking function is described in FIG. 4.

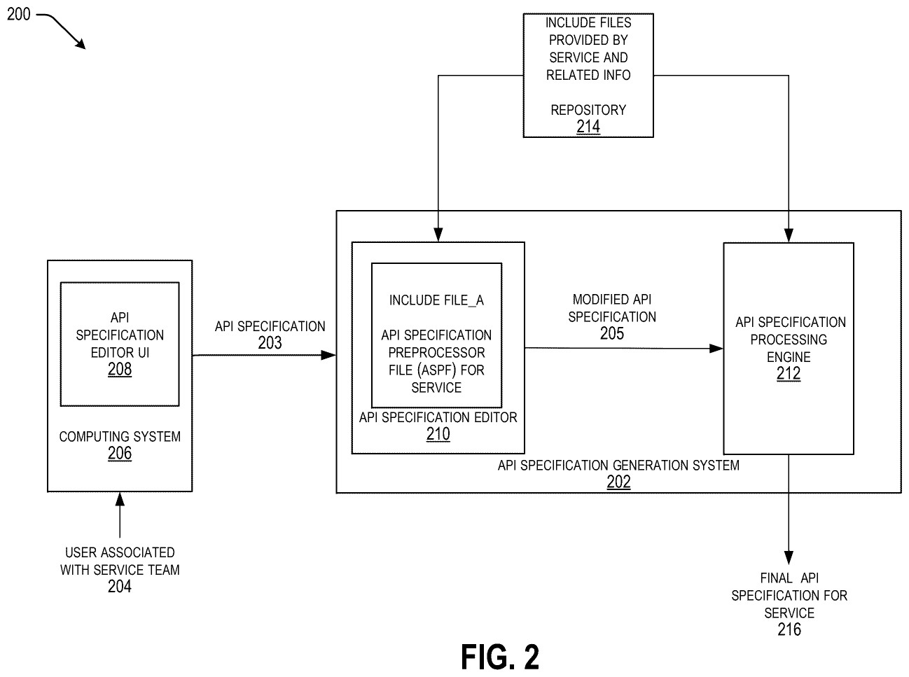

The ASPF for a particular service (e.g., the ASPF 112 for service B, the ASPF 114 for service C or the ASPF 116 for service D) is then provided to an API specification generation system 118 for processing. The API specification generation system 118 processes the ASPF for the service and generates a final API specification (e.g., 120, 122, or 124) for the service based on the processing using automated techniques. Additional details of the operations performed by the API specification generation system to a final API specification for a service based on the ASPF associated with the service is discussed in detail in FIG. 2

FIG. 2 depicts a block diagram of an API specification generation system 202 that includes capabilities for efficiently creating and processing an API specification for a service, according to certain embodiments, according to certain embodiments. The API specification generation system 202 may be implemented by one or more computing systems. For example, the one or more computing systems may execute computer-readable instructions (e.g., code, program) to implement the API specification generation system 202. As depicted in FIG. 1, the API specification generation system 202 includes an API specification editor 210 and an API specification processing engine 212. Portions of data or information used by or generated by the API specification generation system 202 as part of its processing may be stored in a persistent memory such as repository 214. The systems and subsystems depicted in FIG. 1 may be implemented using only software (e.g., code, instructions, program) executed by one or more processing units (e.g., processors, cores) of a computing system, hardware, or combinations thereof. The software may be stored on a non-transitory storage medium (e.g., on a memory device).

Computing environment 100 depicted in FIG. 2 is merely an example and is not intended to unduly limit the scope of claimed embodiments. One of ordinary skill in the art would recognize many possible variations, alternatives, and modifications. For example, in some implementations, the API specification generation system 202 can be implemented using more or fewer subsystems than those shown in FIG. 2, may combine two or more subsystems, or may have a different configuration or arrangement of subsystems.

The API specification generation system 202 may be similar or the same as the API specification generation system 118 depicted in FIG. 1. The API specification generation system 202 may be implemented in various different configurations. In certain embodiments, the API specification generation system 202 may be implemented within an enterprise (e.g., an organization) servicing users of the enterprise. For instance, a user (e.g., belonging to a service team associated with a particular service) within the enterprise may utilize the functionality of the API document generation system 202 to modify or edit an API specification associated with the particular service by adding an include file that describes a function provided by a first service (e.g., a cross-platform team within the enterprise) into the API specification. The user can additionally utilize the functionality of the API document generation system 102 to generate a final API specification for the particular service based on the modified API specification. As part of generating the final API specification, in certain examples, the system may also display the final API specification via a UI of a computing device of the requesting user as described in this disclosure.

In other embodiments, the API specification generation system 202 may be implemented on one or more servers of a cloud provider network and its API specification generation services may be provided to subscribers of cloud services on a subscription basis. The functionality to provide API specification generation, as described in this disclosure, may be offered as part of the service. A customer can subscribe to the service to modify an API specification associated with a service provided by the customer to generate a final API specification for the service. As part of generating the final API specification, in certain examples, the service may also display the final API specification via a UI of a computing device of the requesting subscriber as described in this disclosure.

As shown in the embodiment depicted in FIG. 2, the API specification generation system 202 may be configured to receive as input, an API specification 203 associated with a particular service. The API specification generation system 202 may receive an API specification 203 associated with a particular service in various ways. For instance, in one approach, a user 204 of a service team in an enterprise responsible for the particular service (e.g., service B, service C, or service D as depicted in FIG. 1) may provide an API specification 203 associated with the particular service to the API specification generation system for processing. In other approaches, the API specification associated with a particular service may be provided via a cloud service or a third party system to the specification generation system 202 for processing. As previously described, the API specification is a document that describes the resources and functions provided by the service in an API description format. The API description comprises a set of operations (functions) that can be applied to resources used by the service. The API description additionally describes the API endpoint and operations on each endpoint used by the API, operation parameters (input and output parameters) used by each operation, authentication methods used by the API, license information for the API and so on. In certain examples, the API specification may be described using an API description format such as the OpenAPI Specification format (also known as the Swagger API Specification format).

In certain examples, the user 204 may interact with the API specification generation system 202 via a User Interface (UI) 208 of an API specification editor in the API specification generation system 202. The UI 208 may be displayed on the user's computing system 206. The computing system 206 may be communicatively coupled to the API specification generation system, possibly via one or more communication networks. The computing system may be of various types, including but not limited to, a mobile phone, a tablet, a desktop computer, and the like. The user 204 may, via the UI, interact with an API specification editor by providing as input an API specification 203 associated with a service. The user may via the UI, then edit or modify the API specification by identifying and adding information associated with an include file into the API specification. In certain examples, the include file may be identified by specifying path information in the API specification. The path information identifies a location (e.g., a URL) of the include file stored in a repository (e.g., 214) of the API specification generation system 202.

In certain examples, the repository 214 may be configured to store multiple include files associated with a service (e.g., a cross-platform service) within an enterprise for use by various other services and service teams within the enterprise. The “include file” for a function comprises a description of the function, the operations defined by the function, the input and output parameters of the operations defined the function, the endpoint of each operation, the request and response schema associated with each operation and so on. Different include files can be created to describe different functions provided by the first service, where each include file comprises a description of a specific function provided by the first service. For instance, a first include file can be created to describe a resource locking function, a second include file can be created to describe a compartment change function and so on.

In certain examples, the user may via the UI, edit or modify the API specification to additionally add one or more resource-specific scope portions. A resource-specific scope portion identifies a resource type that is to be used by the function described in the include file. Multiple resource-specific scope portions may be defined in the API specification to utilize the include file for various resource types provided by the service. The resulting modified API specification comprising the include file and the resource-specific scope portions as described above represents an intermediate API specification (also referred to herein as an API specification preprocessor file (ASPF)) for the service.

Upon generating the ASPF as described above, the user can select a “Submit” button via the UI to transmit the ASPF to the API specification processing engine for processing. The API specification processing engine generates a final API specification for the service in an automated manner by processing the ASPF that includes the include file and the resource specific scope portions. In certain examples, processing the ASPF may include obtaining the content (e.g., the code) implemented by the function described in the include file from the repository and merging the content into the ASPF to generate the final API specification. The results of the processing performed by the API document generation system 102 are then communicated back to the computing device. The results may include the final API document, and possibly other information included in the results. The results may be output to the user via a UI of the computing device. Details related to the processing performed by the various systems and subsystems in FIG. 1 for generating a final API document are described below with respect to the flowchart depicted in FIG. 2 and the accompanying description.

An example of an include file that describes a resource locking function provided by a first service is described below. The “include file” for the function comprises a description of a set of API operations supported by the function, input and output parameters of the function, the endpoint of the function, the request and response schema associated with the function and so on. In a certain implementation, the content within the include file can be composed of multiple sections and described using an API description format such as the OpenAPI specification (Swagger Specification). In certain examples, the include file may be implemented as a YAML (Yet Another Markup Language) file or a JSON (JavaScript Object Notation) file.

The include file illustrated below is merely an example of an include file created for a resource locking function and is not intended to unduly limit the scope of claimed embodiments. One of ordinary skill in the art would recognize many possible variations, alternatives, and modifications. For example, in some implementations, the include file may be composed of more or fewer sections and each section may identify more or fewer pieces of information than what is illustrated below.

### Example of an Include File that Describes a Resource Locking Function

An example of an include file that describes a resource locking function provided by a first service (e.g., service A depicted in FIG. 1) is shown below. In one implementation, the include file may be composed of multiple sections. The first section in the include file comprises information that describes how a particular service can utilize the include file in its API specification. This section describes a set of path-level resource parameters that are shared by a set of operations supported by the function described in the include file. The path-level resource parameters are inherited by all the operations of that path. For instance, in the example shown below, the first section describes a set of path-level parameters (e.g., a resource path parameter, a resource locking operation parameter, a resource name parameter and a resource identifier path parameter) that are shared by a set of operations (e.g., an addlock ( ) operation and a removelock ( ) operation) supported by the resource locking function.

In certain examples, the set of path-level resource parameters may be defined within a scope portion that is defined by a “beginscope” keyword and an “endscope” keyword. The scope portion additionally identifies a type of resource (e.g., an instance resource) that is used by the function described in the include file and a specifies a location (e.g., a URL, include_indented/resource-locking-api-spec-include/source/paths.cond.yaml) of the include file. As will be described in FIG. 3, the scope portion enables the nesting of include files and supports safe resource parameter substitution when the include file is used in conjunction with various resource types (e.g., instances, images, buckets and so on) provided by the service in an API specification associated with the service.

Include File Example: First Section

#paths:

| | |
|---|---|
| # | /instances: |
| # | # ... |
| # | @beginscope |
| # | @setvar RESOURCE_PATH /instances/ {instanceId} |
| # | @setvar RESOURCE_LOCKING_OPERATION_TAGS [‘Compute’] |
| # | @setvar RESOURCE_NAME Instance |
| # | @setvar RESOURCE_DEFINITION_NAME @@RESOURCE_NAME@@ |
| # | @setvar RESOURCE_ID_PATH_PARAMETER_NAME InstanceIdPathParam |
| # | @setvar_multiline RESOURCE_LOCKING_ADD_LOCK_OPTIONAL_SETTINGS |
| # | x-obmcs-splat: |
| # | maximumAttemptCount: 3 |
| # | @endsetvar |
| # | @setvar RESOURCE_LOCKING_REMOVE_LOCK_OPTIONAL_SETTINGS # Nothing to add for removeLock |

operation

| | |
|---|---|
| # | @include_indented /resource-locking-api-spec-include/source/paths.cond.yaml |
| # | @endscope |

An example of the information identified in a second section in the include file is shown below. In one implementation, the second section describes additional details of how a particular service can utilize the include file in its API specification. This section describes information associated with the required variable settings and the optional variable settings for a type of resource (e.g., an instance resource) that can be used by one or more operations supported by the function described in the include file. In the example shown below, the required variable settings for the “instance” resource comprise a resource path for getting resources of the resource type, resource locking operation tags that are attached to the operations (addlock ( ) operation and removelock ( ) operation) performed on the resource, the resource definition name, the resource path parameter name and so on.

Include File Example: Second Section

REQUIRED VARIABLE SETTINGS:
#

| | |
|---|---|
| # | ‘RESOURCE_PATH’ |
| # | This should be the path used for getting an individual resource, including the proper |

placeholder.

| | |
|---|---|
| # | Example: @setvar RESOURCE_PATH /instances/ {instanceId} |
| # | Actual value: @@RESOURCE_PATH@@ |
| # | ‘RESOURCE_LOCKING_OPERATION_TAGS |
| # | This should be the OpenAPI tags attached to the add/remove lock operations. This is used to |

determine the SDK client these operations appear in.

| | |
|---|---|
| # | Example: @setvar RESOURCE_LOCKING_OPERATION_TAGS [‘Compute’] |
| # | Actual value: @@RESOURCE_LOCKING_OPERATION_TAGS@@ |

#

| | |
|---|---|
| # | ‘RESOURCE_NAME’ |
| # | This should be the resource name, starting with a capital letter. |
| # | Example: @setvar RESOURCE_NAME Instance |
| # | Actual value: @@RESOURCE_NAME@@ |

#

| | |
|---|---|
| # | ‘RESOURCE_DEFINITION_NAME’ |
| # | The name of the resource model, from the definitions: section. Most likely the same as |

@@RESOURCE_NAME@@.

| | |
|---|---|
| # | Example: @setvar RESOURCE_DEFINITION_NAME Instance |
| # | Actual value: @@RESOURCE_DEFINITION_NAME@@ |

#

| | |
|---|---|
| # | ‘RESOURCE_ID_PATH_PARAMETER_NAME’ |
| # | This should be the parameter name, from the parameters: section, of the path parameter |
| # | consuming the resource OCID. |
| # | Example: @setvar RESOURCE_ID_PATH_PARAMETER_NAME InstanceIdPathParam |
| # | Actual value: @@RESOURCE_ID_PATH_PARAMETER_NAME@@ |

#

| | |
|---|---|
| # | ‘ADD_LOCK_OPERATION_OPTIONAL_SETTINGS’ |
| # | Optional settings for the addLock operation, e.g. x-obmcs-splat settings. |
| # | This must be set, but it can be set to an empty value. |
| # | Actual value: @@ADD_LOCK_OPERATION_OPTIONAL_SETTINGS@@ |

#

| | |
|---|---|
| # | ‘REMOVE_LOCK_OPERATION_OPTIONAL_SETTINGS’ |
| # | Optional settings for the removeLock operation, e.g. x-obmcs-splat settings. |
| # | This must be set, but it can be set to an empty value. |
| # | Actual value: @@REMOVE_LOCK_OPERATION_OPTIONAL_SETTINGS@ |

An example of the information identified in a third section in the include file is shown below. In one implementation, the third section in the include file describes information identifying a first type of operation that is supported by the function. In the example shown below, the third section describes the input parameters and output parameters defined by an Addlock ( ) operation, the request and response schema associated with the operation and so on.

Include File Example: Third Section

```
@@RESOURCE_PATH@@/actions/addLock:
  post:
    operationId: Add@@RESOURCE_NAME@@Lock
    summary: Adds a lock to a @@RESOURCE_NAME@@ resource.
    description: Adds a lock to a @@RESOURCE_NAME@@ resource.
    tags: @@RESOURCE_LOCKING_OPERATION_TAGS@@
    x-related-resource: ‘#/definitions/@@RESOURCE_DEFINITION_NAME@@’
    @@ADD_LOCK_OPERATION_OPTIONAL_SETTINGS@@
    produces:
    - application/json
    parameters:
    - name: opc-request-id
      description: |
        Unique identifier for the request.
      in: header
      type: string
      required: false
    - name: if-match
      description: |
      responses:
      200:
        description: Lock is added.
        schema:
          $ref: ‘#/definitions/@@RESOURCE_DEFINITION_NAME@@’
        headers:
          opc-request-id:
            description: |
              Unique Oracle-assigned identifier for the request. If you need to contact
              Oracle about a particular request, please provide the request ID.
            type: string
          etag:
            description: |
              etag for the returned @@RESOURCE_NAME@@ resource.
            type: string
      400:
        $ref: ‘#/responses/400’
      401:
        $ref: ‘#/responses/401’
      404:
        $ref: ‘#/responses/404’
      412:
        $ref: ‘#/responses/412’
      429:
        $ref: ‘#/responses/429’
      500:
        $ref: ‘#/responses/500’
      default:
        $ref: ‘#/responses/DefaultError’
```

An example of the information identified in a fourth section in the include file is shown below. In one implementation, the fourth section in the include file describes information identifying a second type of operation that is supported by the function. In the example shown below. In the example shown below, the fourth section describes information such as input parameters and output parameters defined by the Removelock ( ) operation, the request and response schema associated with the operation and so on:

Include File Example: Fourth Section

```
@@RESOURCE_PATH@@/actions/removeLock:
  post:
    operationId: Remove@@RESOURCE_NAME@@Lock
    summary: Removes a lock to a @@RESOURCE_NAME@@ resource.
    description: Removes a lock from a @@RESOURCE_NAME@@ resource.
    tags: @@RESOURCE_LOCKING_OPERATION_TAGS@@
    x-related-resource: ‘#/definitions/@@RESOURCE_DEFINITION_NAME@@’
    @@REMOVE_LOCK_OPERATION_OPTIONAL_SETTINGS@@
    produces:
    - application/json
    parameters:
    - name: opc-request-id
      description: |
        Unique identifier for the request.
      in: header
      type: string
      required: false
    - name: if-match
      description: |
          schema :
            $ref: ‘#/definitions/@@RESOURCE_DEFINITION_NAME@@’
        headers:
            opc-request-id:
              description: |
                Unique Oracle-assigned identifier for the request.
              type: string
            etag:
              description: |
                etag for the returned @@RESOURCE_NAME@@ resource.
              type: string
      400:
        $ref: ‘#/responses/400’
      401:
        $ref: ‘#/responses/401’
      404:
        $ref: ‘#/responses/404’
      412:
        $ref: ‘#/responses/412’
      429:
        $ref: ‘#/responses/429’
      500:
        $ref: ‘#/responses/500’
      default:
        $ref: ‘#/responses/DefaultError’
```

As previously described, in certain embodiments, a service (e.g., service B 106, service C 108, or service D 110 depicted in FIG. 1) within an enterprise may utilize the include file described above by identifying and adding the include file into the API specification associated with the service. For example, a user of a service team responsible for a particular service (service A 106, service B 108, or service C 110) may identify and add the include file into the API specification associated the service via the API specification editor UI 208 depicted in FIG. 2. The utilize the function (i.e., the resource locking function) described in the include file in conjunction with various resource types (e.g., instances, images, buckets and so on) provided by the service, the user may additionally modify the API specification to define one or more resource-specific scope portions in the API specification. Each resource-specific scope portion identifies a resource type that is used by the service. The modified API specification comprising the include file and the resource-specific scope portions defined for the include file represents an intermediate API specification (also referred to herein as an API specification preprocessor file (ASPF)) for the service as described in FIG. 3 below.

FIG. 3 is an illustration of an API specification preprocessor file (ASPF)) created for a service, according to certain embodiments. As previously described, the ASPF represents an intermediate API specification that is created for a service by modifying the API specification associated with the service by adding an include file and defining resource-specific scope portions that enable the include file to be applied to various resource types provided by the service. In one implementation and as depicted in FIG. 3, the ASPF 300 comprises a first resource-specific scope 304 and a second resource-specific scope 306. A resource specific scope (304 or 306) in the ASPF refers to a block or region in the ASPF where resources of a particular resource type (e.g., an instance resource) may be defined and used. The resources of the particular type are only visible and accessible to the code defined in the resource-specific scope.

In the embodiment illustrated in FIG. 3, the first resource-specific scope 304 identifies a first resource type (e.g., a “deployment” resource) used by the service. The resource type is identified by setting a resource name parameter (e.g., “deployment”) used by the function to the resource type in the first resource-specific scope portion. The first resource-specific scope portion also identifies additional resource parameters such as a resource path, resource locking operation tags, a resource definition, a resource path parameter name, optional parameter settings (if any) that are applicable to the “deployment” type resource. The first resource-specific scope portion also specifies how the service can access and utilize the include file by identifying a location (e.g., a URL) of the include file: @include_indented/resource-locking-api-spec-include/source/paths.cond.yaml) in a repository. The beginning of the first resource-specific scope portion is identified using a first keyword (e.g. beginscope) and the end of the first resource-specific scope portion is identified using a second keyword (e.g., endscope).

The second resource-specific scope portion 304 identifies a second resource type (e.g., a “bucket” resource) used by the service. The resource type is identified by setting a resource name parameter (“bucket”) used by the function to the resource type in the second resource-specific scope portion. The second resource-specific scope portion additionally identifies one or more resource parameters such as a resource path, resource locking operation tags, a resource definition, a resource path parameter name, optional parameter settings (if any) that are applicable to the “bucket” type resource. The second resource-specific scope portion also specifies how the service can access and utilize the include file by identifying a location (e.g., a URL) of the include file: include_indented/resource-locking-api-spec-include/source/paths.cond.yaml) in a repository. The beginning of the second resource-specific scope portion is identified using a first keyword (e.g. beginscope) and the end of the second resource-specific scope portion is identified using a second keyword (e.g., endscope).

The resource-specific scope defined by the “beginscope” keyword and the “endscope” keyword enable safe resource parameter substitution by the operations supported by the function described in an include file. For instance, when the scope is set to “deployment” (e.g., in in the first resource-specific scope portion 304) in the include file, the set of operations (Addlock, Removelock) supported by the ResourceLock ( ) function described in the include file can be applied to all “deployment” resources provided by the service. When the scope is set to “bucket” (e.g., in the second resource-specific scope portion 306), the set of operations (Addlock, Removelock) supported by the ResourceLock ( ) function specified in the include file can be applied to all “instance” resources provided by the service.

In certain examples, the ASPF 300 may also include information 308 that identifies the latest version (e.g., 1.0.1) of the include file that is being used by the service. The ASPF illustrated in FIG. 4 is merely an example of an ASPF created for a service and is not intended to unduly limit the scope of claimed embodiments. One of ordinary skill in the art would recognize many possible variations, alternatives, and modifications. For example, in some implementations, the ASPF may be composed of more or fewer resource-specific scopes than what is illustrated in FIG. 4 and each resource-specific scope may identify different or additional information associated with one or more resource types used by the service.

In certain examples, multiple include files can be nested within the ASPF for a service. For instance, a smaller include file can be nested within a larger include file, where the smaller include file can be used to describe a subset of operations that can be applied to a particular resource type used by the service and the larger include file can be used to describe the entire set of operations that can be applied to the resource type. For instance, a larger include file can be created that describes the entire set of CRUD operations (Create/Read/Update/Delete/List) that can be applied to an “instance” resource type supported by a function. Since some of the CRUD operations (e.g., Update and Delete) are similar, a subset of the operations (e.g., Update and Delete) can be implemented using a nested include file that describes these modifying operations.

In certain implementations, the use of different scopes as described above enables the include files to be combined/nested in any order by using different resource parameter names in each of the include files. For instance, in certain situations, the larger include file can identify a resource of a particular type (e.g., an “instance” resource) using a resource name parameter (e.g., “instance) in the larger include file. The nested include file can identify a resource of a different type (e.g., a “bucket” resource). By using different scope portions for the two include files, the resource name parameter can be set to “instance” in the scope portion defined for the larger include file and the resource name parameter can be set to “Bucket” in the scope portion defined for the nested include file. Once the nested (inner) include file is executed, the previous value of the resource name parameter (i.e., instance) will be restored can used by the larger (outer) include file.

FIG. 4 depicts an example of a process 400 performed by the API specification generation system shown in FIG. 1, according to certain embodiments. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 400 presented in FIG. 4 and described below is intended to be illustrative and non-limiting. Although FIG. 4 depicts the various processing steps occurring in a particular sequence or order, this is not intended to be limiting. In certain alternative embodiments, the steps may be performed in some different order or some steps may also be performed in parallel.

The processing depicted in FIG. 4 is initiated at block 402 when the API specification generation system (e.g., the API specification generation system 202 depicted in FIG. 2) obtains information that identifies an include file that describes a function provided by a first service. As previously described, the first service (e.g. service A 102 depicted in FIG. 1) may represent a cross-platform service within the enterprise that is capable of providing various types of functions to multiple other services (e.g., service B 106, service C 108 and service D 110) within the enterprise. The “include file” for a function comprises a detailed description of the function such as the input and output parameters of the function, the endpoint of the function, the request and response schema associated with the function and so on. In a certain implementation, and as described in FIG. 2, the API specification generation system may obtain the information that identifies an include file from a user (e.g., 204) of a service team responsible for the second service via a User Interface (UI) 208 of an API specification editor 210 in the API specification generation system 202.

At block 404, the API specification generation system adds the information identifying the “include file” in the API specification for a second service. In a certain implementation, the information identifying the include file can be added by the user (e.g., 204) via the UI 208 by specifying path information that identifies a location (e.g., a URL) of the include file stored in a repository (e.g., 214) of the API specification generation system. As described above, the second service uses the function described in the include file for a set of one or more resource types (e.g., instances, images, buckets, databases etc.) provided by the second service. The user may additionally modify the API specification via the UI 208 to define one or more resource-specific scope portions in the API specification. Each resource-specific scope portion identifies a resource type that used by the service.

At block 406, the API specification generation system generates a modified API specification for the second service based on the include file and the resource-specific scope portions. The modified API specification represents an API specification preprocessor file (ASPF)) created for the second service. An example of an ASPF created for a service is described in FIG. 3 above.

At block 408, the API specification generation system processes the modified API specification to generate a final API specification for the second service. In certain examples, processing the ASPF may include obtaining the content (e.g., the code) implemented by the function described in the include file from the repository and merging the content into the ASPF to generate the final API specification. The results of the processing performed by the API document generation system 102 are then communicated back to the requesting user at the computing device.

The various embodiments described in the present disclosure address the deficiencies of existing approaches by disclosing an API specification generation system that facilitates the efficient creation and processing of an API specification for a service. By identifying and providing an include file that comprises a detailed description of the function in an API specification associated with the service as described above, when a modification is made to the original function description, only the modified and upgraded version of the include file needs to be made available (e.g., by a service team that provides the include file) to other services that want to utilize the function described in the include file. Additionally, since the include file can be used in conjunction with various resource types provided by the service, the entire function description does not have to be copied each time the function is used for various resource types provided by the service. Thus, by creating and using include files as described in this disclosure, service teams do not have to copy and amend the function description multiple times within the API specification which is a manual and time consuming process that is prone to errors.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

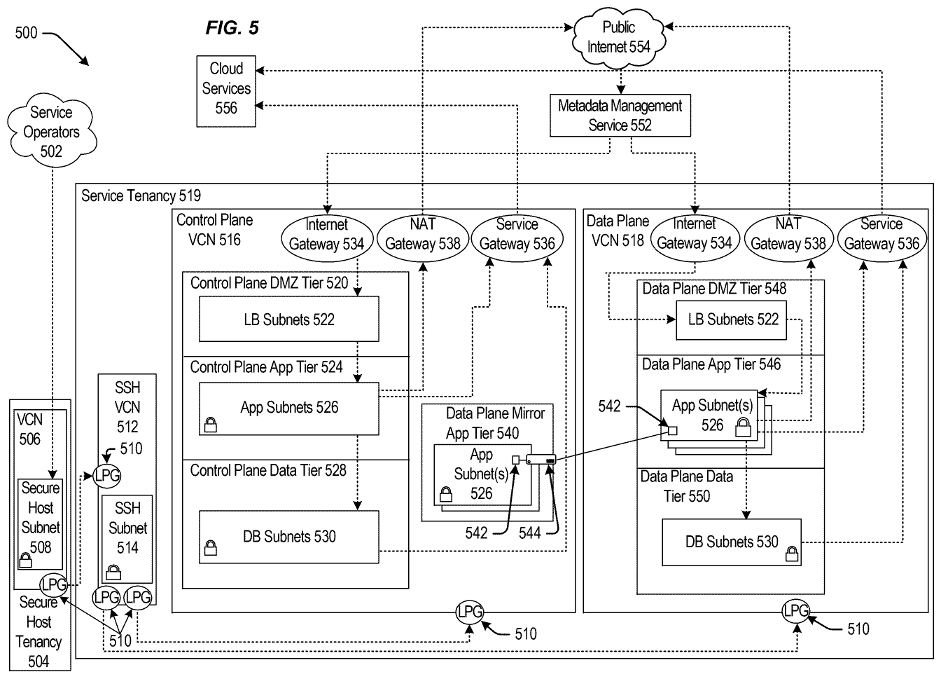

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users′, or other customers′, resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

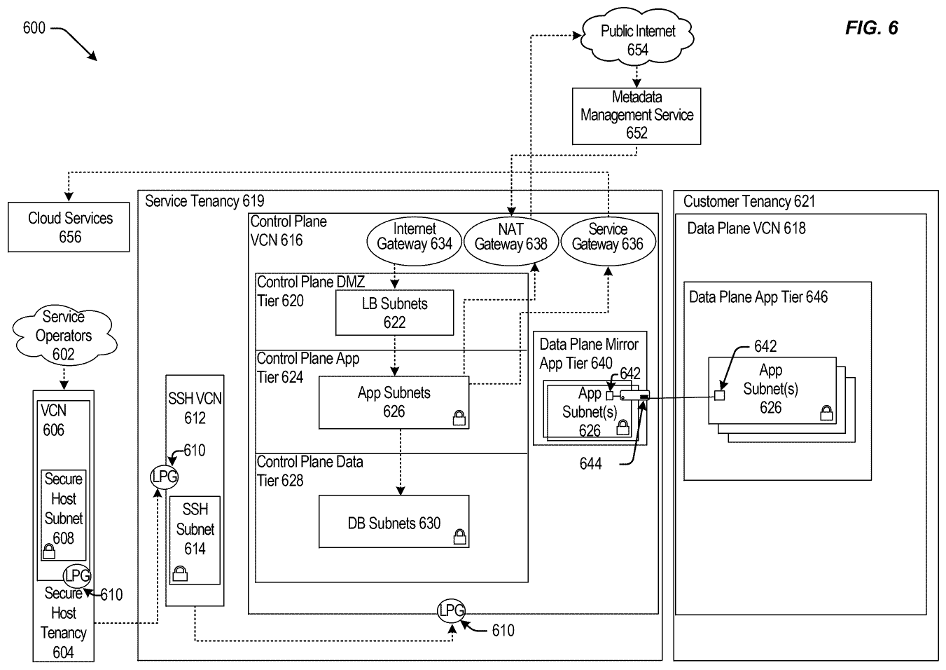

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

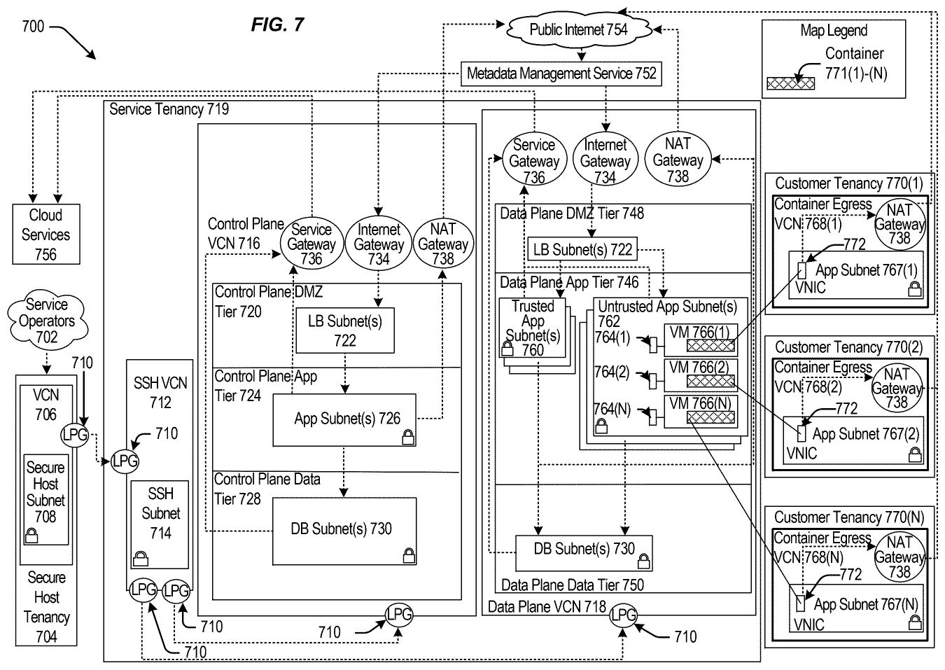

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

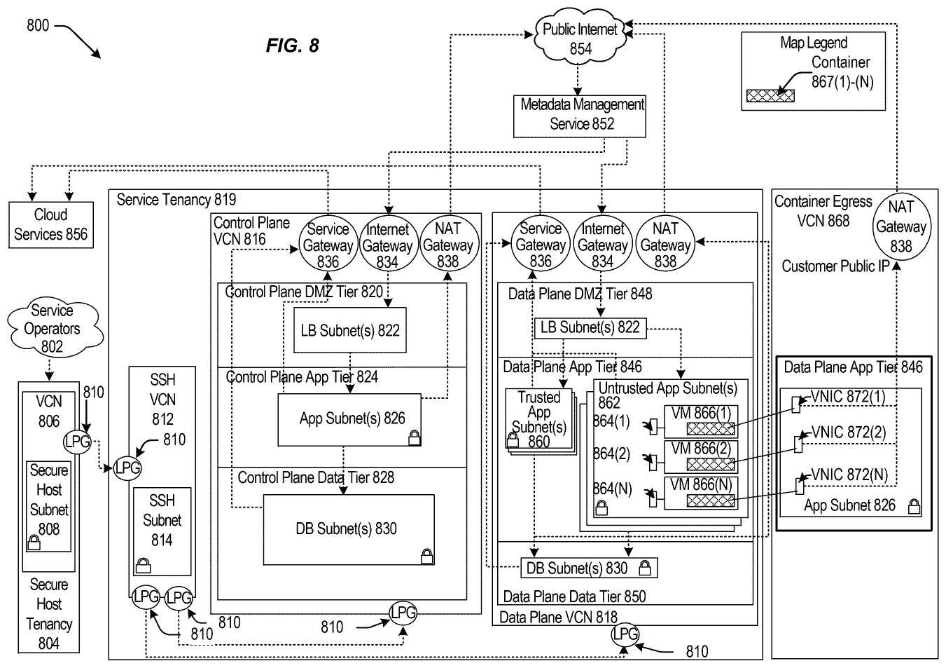

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICS 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

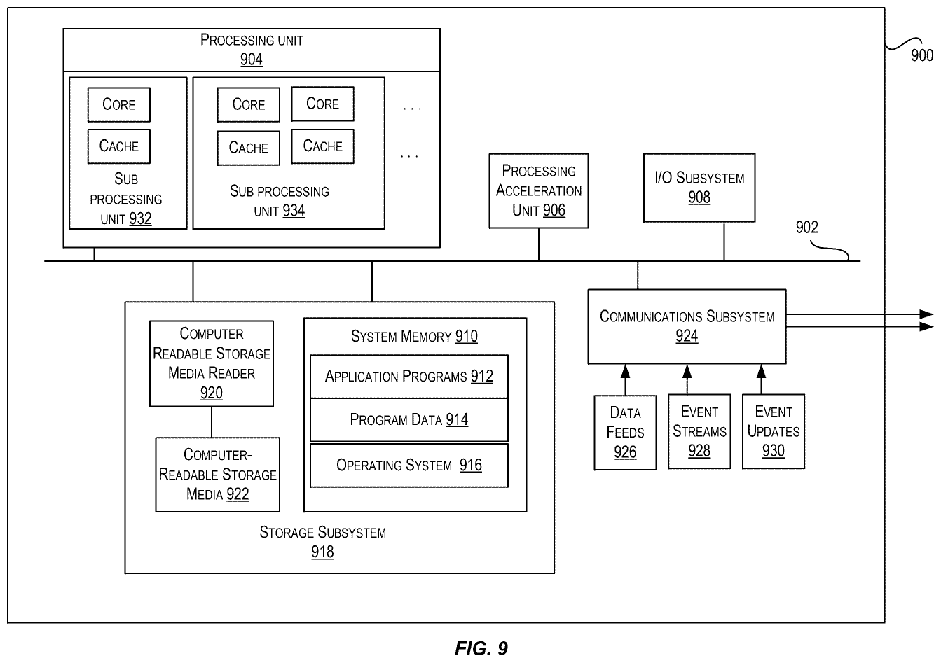

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present disclosure.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
obtaining, by an Application Programing Interface (API) generation system, information identifying an include file, wherein the include file describes a function provided by a first service;
providing, by the API generation system, the information identifying the include file in an Application Programing Interface (API) specification for a second service, wherein the second service uses the function described in the include file for a set of one or more resource types provided by the second service;
generating, by the API generation system, a modified API specification for the second service based on the include file; and
processing, by the API generation system, the modified API specification to generate a final API specification for the second service.

2. The method of claim 1, wherein the function described in the include file is not copied into the API specification for the second service.

3. The method of claim 1 further comprising obtaining, by the API generation system, information identifying one or more resource-specific scope portions for describing application of the function described in the include file to the set of one or more resource types provided by the second service.

4. The method of claim 3, wherein a first resource-specific scope portion from the one or more resource-specific scope portions identifies a first resource type from the set of one or more resource types provided by the second service.

5. The method of claim 4, wherein the first resource type is identified by setting a resource name parameter used by the function to the first resource type in the first resource-specific portion.

6. The method of claim 3, wherein a second resource-specific scope portion from the one or more resource-specific scope portions identifies a second resource type from the set of one or more resource types provided by the second service.

7. The method of claim 6, wherein the second resource type is identified by setting a resource name parameter used by the function to the second resource type in the second resource-specific scope portion.

8. The method of claim 1, wherein a first resource type from the set of one or more resource types provided by the second service is different from a second resource type from the set of one or more resource types provided by the second service.

9. The method of claim 4, further comprising adding, by the API specification generation system, the one or more resource-specific scope portions into the API specification for the second service to generate the modified API specification.

10. The method of claim 9, wherein the one or more resource-specific scope portions are added into the API specification for the second service via a User Interface (UI) of the API generation system.

11. The method of claim 1, further comprising providing, by the API generation system, the include file in the API specification for a third service, wherein the third service uses the function for a set of one or more resource types provided by the third service, wherein the function described in the include file is not copied into the API specification for the third service.

12. The method of claim 1, wherein the information identifying the include file that describes the function provided by the first service is added to the API specification of the second service via a User Interface (UI) of the API specification generation system.

13. The method of claim 1 further comprising providing the final API specification to a requesting user via a User Interface (UI) of the API specification generation system.

14. An Application Programing Interface (API) generation system comprising:
a memory; and
one or more processors configured to perform processing, the processing comprising:
obtaining information identifying an include file, wherein the include file describes a function provided by a first service;
providing the information identifying the include file in an Application Programing Interface (API) specification for a second service, wherein the second service uses the function described in the include file for a set of one or more resource types provided by the second service;
generating a modified API specification for the second service based on the include file; and
processing the modified API specification to generate a final API specification for the second service.

15. The system of claim 14, wherein the function described in the include file is not copied into the API specification for the second service.

16. The system of claim 14 further comprising obtaining information identifying one or more resource-specific scope portions for describing application of the function described in the include file to the set of one or more resource types provided by the second service.

17. The system of claim 16, further comprising adding the one or more resource-specific scope portions into the API specification for the second service to generate the modified API specification.

18. A non-transitory computer-readable medium storing instructions executable by a computer system that, when executed by one or more processors of the computer system, cause the one or more processors to perform operations comprising:
obtaining information identifying an include file, wherein the include file describes a function provided by a first service;
providing the information identifying the include file in an Application Programing Interface (API) specification for a second service, wherein the second service uses the function described in the include file for a set of one or more resource types provided by the second service;
generating a modified API specification for the second service based on the include file; and
processing the modified API specification to generate a final API specification for the second service.

19. The non-transitory computer-readable medium of claim 18, wherein the function described in the include file is not copied into the API specification for the second service.

20. The non-transitory computer-readable medium of claim 18, wherein a first resource type from the set of one or more resource types provided by the second service is different from a second resource type from the set of one or more resource types provided by the second service.
